(19) United States
(12) Patent Application Publication
(10) Pub. No.: US 2024/0411461 A1
(43) Pub. Date: Dec. 12, 2024

(54) METHOD AND APPARATUS FOR PERFORMING ACCESS CONTROL OF MEMORY DEVICE WITH AID OF INTERRUPT MANAGEMENT

(71) Applicant: Silicon Motion, Inc., Hsinchu County (TW)

(72) Inventor: Cheng-Yu Tsai, Kaohsiung City (TW)

(73) Assignee: Silicon Motion, Inc., Hsinchu County (TW)

(21) Appl. No.: 18/666,851

(22) Filed: May 17, 2024

(30) Foreign Application Priority Data
Jun. 8, 2023 (TW) 112121419

(51) Int. Cl. G06F 3/06

(52) U.S. Cl. CPC G06F 3/0622; G06F 3/0659; G06F 3/0673

(57) ABSTRACT

A method for performing access control of a memory device with aid of interrupt management includes: utilizing a memory controller to receive a set of commands from a host device through a transmission interface circuit of the memory controller; and in response to the set of commands, utilizing the memory controller to perform a set of accessing operations upon a non-volatile (NV) memory for the host device, and return a single message-signaled interrupt (MSI) corresponding to the set of commands to the host device through the transmission interface circuit, for notifying the host device of completion of device side access control of the memory device regarding the set of commands, to allow the host device to complete host side access control of the host device regarding the set of commands.

### BACKGROUND OF THE INVENTION

### 1. Field of the Invention

The present invention is related to memory control, and more particularly, to a method for performing access control of a memory device with aid of interrupt management, and an associated apparatus (e.g., a memory controller of the memory device, the memory device, and an electronic device including the memory device).

### 2. Description of the Prior Art

According to related technologies, a memory device can be designed to have the ability to simultaneously access respective storage units of multiple flash memory chips in the memory device, in order to improve the throughput of data access. Some problems may occur, however. For example, improper control may reduce the above-mentioned throughput. Under a condition that a transmission interface circuit within the memory device is not properly configured, a host accessing the memory device may not be able to complete some accessing operations at ideal respective time points, which may increase a total access time. Thus, a novel method and associated architecture are needed for solving the problems without introducing any side effect or in a way that is less likely to introduce a side effect.

### SUMMARY OF THE INVENTION

It is therefore one of the objectives of the present invention to provide a method for performing access control of a memory device with aid of interrupt management, and an associated apparatus (e.g., a memory controller of the memory device, the memory device, and an electronic device including the memory device), to address the above-mentioned issues.

According to at least one embodiment of the present invention, a method for performing access control of a memory device with aid of interrupt management is provided, wherein the method is applicable to a memory controller of the memory device, the memory device comprises the memory controller and a non-volatile (NV) memory, the NV memory comprises at least one NV memory element (e.g., one or more NV memory elements), and the at least one NV memory element comprises a plurality of blocks. The method comprises: utilizing the memory controller to receive a set of commands from a host device through a transmission interface circuit within the memory controller, wherein a command count of the set of commands is greater than one, and any command among the set of commands indicates a request for accessing the memory device; and in response to the set of commands, utilizing the memory controller to perform a set of accessing operations upon the NV memory for the host device, and return a single message-signaled interrupt (MSI) corresponding to the set of commands to the host device by the transmission interface circuit, for notifying the host device of completion of device side access control of the memory device regarding the set of commands, to allow the host device to complete host side access control of the host device regarding the set of commands, wherein the set of accessing operations comprises a corresponding accessing operation performed by the memory controller in response to the command among the set of commands.

In addition to the above method, the present invention also provides a memory controller of a memory device, wherein the memory device comprises the memory controller and an NV memory. The NV memory comprises at least one NV memory element (e.g., one or more NV memory elements), and the at least one NV memory element comprises a plurality of blocks. In addition, the memory controller comprises a processing circuit that is arranged to control the memory controller according to a plurality of host commands from a host device, to allow the host device to access the NV memory through the memory controller, wherein the processing circuit is arranged to perform access control of the memory device with aid of interrupt management. The memory controller further comprises a transmission interface circuit. The transmission interface circuit is arranged to perform communications with the host device. For example, the memory controller receives a set of commands from the host device through the transmission interface circuit within the memory controller, wherein a command count of the set of commands is greater than one, and any command among the set of commands indicates a request for accessing the memory device. In response to the set of commands, the memory controller performs a set of accessing operations upon the NV memory for the host device, and returns a single message-signaled interrupt (MSI) corresponding to the set of commands to the host device by the transmission interface circuit, for notifying the host device of completion of device side access control of the memory device regarding the set of commands, to allow the host device to complete host side access control of the host device regarding the set of commands, wherein the set of accessing operations comprises a corresponding accessing operation performed by the memory controller in response to the command among the set of commands.

In addition to the method mentioned above, the present invention also provides the memory device comprising the memory controller mentioned above, wherein the memory device comprises: the NV memory, configured to store information; and the memory controller, coupled to the NV memory, configured to control operations of the memory device.

In addition to the method mentioned above, the present invention also provides an electronic device comprising the memory device mentioned above, wherein the electronic device further comprises the host device that is coupled to the memory device. The host device may comprise: at least one processor, arranged for controlling operations of the host device; and a power supply circuit, coupled to the at least one processor, arranged for providing power to the at least one processor and the memory device. In addition, the memory device provides the host device with storage space.

According to some embodiments, the apparatus may comprise at least one portion (e.g., a portion or all) of the electronic device. For example, the apparatus may comprise the memory controller within the memory device. In another example, the apparatus may comprise the memory device. In yet another example, the apparatus may comprise the electronic device.

According to some embodiments, the memory controller in the memory device may control operations of the memory device according to the method, and the memory device may be set in the electronic device. In addition, the memory device may store data for the host device. The memory device may read stored data in response to a host command from the host device, and provide data read from the NV memory to the host device.

The method and apparatus of the present invention can guarantee that the memory device can operate properly in various situations, and more particularly, can dynamically adjust configurations of the memory device to optimize host side access control. For example, by dynamically adjusting aggregation parameters (e.g., an aggregation threshold and an aggregation time), access control can be performed in response to the latest state of the electronic device (or the host device and/or the memory device therein), for improving throughput regarding data access. In addition, the present invention method and apparatus can solve the related art problems without introducing any side effect or in a way that is less likely to introduce a side effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device according to an embodiment of the present invention.

FIG. 2A is a diagram illustrating an interrupt coalescing controller according to an embodiment of the present invention.

FIG. 2B is a diagram illustrating an example of implementation details of the circuit architecture shown in FIG. 2A.

FIG. 2C is a diagram illustrating another example of implementation details of the circuit architecture shown in FIG. 2A.

FIG. 3 illustrates, in the right half thereof, a dynamically optimized access control scheme according to an embodiment of the present invention, wherein a non-optimized access control scheme is illustrated in the left half of FIG. 3 for better comprehension.

FIG. 4 is a flow chart of a method for performing access control of a memory device with aid of interrupt management according to an embodiment of the present invention.

FIG. 5 is a diagram illustrating some examples of timing diagrams regarding access control.

FIG. 6 is a diagram illustrating another example of a timing diagram regarding access control.

FIG. 7 is a diagram illustrating some other examples of timing diagrams regarding access control.

FIG. 8 is a diagram illustrating some further examples of timing diagrams regarding access control.

FIG. 9A is a diagram illustrating a work flow of a serving input/output (I/O) command routine involved in the method according to an embodiment of the present invention.

FIG. 9B is a diagram illustrating a work flow of an interrupt service routine (ISR) involved in the serving I/O command routine shown in FIG. 9A.

FIG. 10A is a diagram illustrating an example of access control involved in the method.

FIG. 10B is a diagram illustrating another example of access control involved in the method.

### DETAILED DESCRIPTION

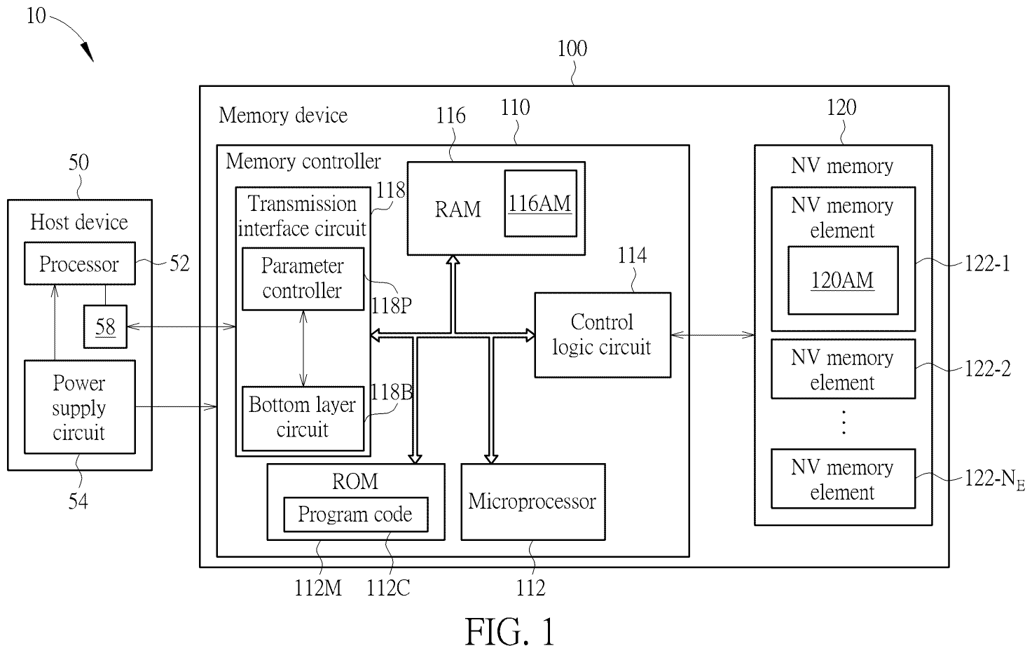

FIG. 1 is a diagram illustrating an electronic device 10 according to an embodiment of the present invention, where the electronic device 10 may include a host device 50 and a memory device 100. The host device 50 may include at least one processor (e.g., one or more processors) which may be collectively referred to as a processor 52, a power supply circuit 54, and a transmission interface circuit 58, where the processor 52 and the transmission interface circuit 58 may be coupled to each other through a bus, and may be coupled to the power supply circuit 54 to obtain power. The processor 52 may be arranged to control operations of the host device 50, and the power supply circuit 54 may be arranged to provide the processor 52, the transmission interface circuit 58, and the memory device 100 with power, and output one or more driving voltages to the memory device 100, where the memory device 100 may provide the host device 50 with storage space, and may obtain the one or more driving voltages from the host device 50, to be the power of the memory device 100. Examples of the host device 50 may include, but are not limited to: a multifunctional mobile phone, a tablet computer, a wearable device, and a personal computer such as a desktop computer and a laptop computer. Examples of the memory device 100 may include, but are not limited to: a portable memory device (e.g., a memory card conforming to the SD/MMC, CF, MS or XD specification), a solid state drive (SSD), and various types of embedded memory devices (e.g., an embedded memory device conforming to the UFS or eMMC specification). According to this embodiment, the memory device 100 may include a controller such as a memory controller 110, and may further include a non-volatile (NV) memory 120, where the controller is arranged to access the NV memory 120, and the NV memory 120 is arranged to store information. The NV memory 120 may include at least one NV memory element (e.g., one or more NV memory elements), such as a plurality of NV memory elements 122-1, 122-2, . . . , and 122-N_{E}, where “N_{E}” may represent a positive integer that is greater than one. For example, the NV memory 120 may be a flash memory, and the plurality of NV memory elements 122-1, 122-2, . . . , and 122-N_{E} may be a plurality of flash memory chips or a plurality of flash memory dies, respectively, but the present invention is not limited thereto.

As shown in FIG. 1, the memory controller 110 may include a processing circuit such as a microprocessor 112, a storage unit such as a read only memory (ROM) 112M, a control logic circuit 114, a Random Access Memory (RAM) 116, and a transmission interface circuit 118, where at least one portion (e.g., a portion or all) of the above components may be coupled to one another via a bus. The transmission interface circuit 118 may include multiple sub-circuits, such as a bottom layer circuit 118B (e.g., a physical layer (PHY) circuit) and a parameter controller 118P, wherein the parameter controller 118P may be arranged to control multiple parameters of the bottom layer circuit 118B. The RAM 116 may be arranged to provide the memory controller 110 with internal storage space (e.g., may temporarily store information), but the present invention is not limited thereto. In addition, the ROM 112M of this embodiment is arranged to store a program code 112C, and the microprocessor 112 is arranged to execute the program code 112C to control the access of the NV memory 120. Note that the program code 112C may also be stored in the RAM 116 or any type of memory. Additionally, the control logic circuit 114 may be arranged to control the NV memory 120. The control logic circuit 114 may include an error correction code (ECC) circuit (not shown in FIG. 1), wherein the ECC circuit may perform ECC encoding and ECC decoding to protect data and/or perform error correction. The transmission interface circuit 118 may conform to one or more communications specifications among various communications specifications (e.g., the Serial Advanced Technology Attachment (SATA) specification, Universal Serial Bus (USB) specification, Peripheral Component Interconnect Express (PCIe) specification, embedded Multi Media Card (eMMC) specification, and Universal Flash Storage (UFS) specification), and may perform communications with the host device 50 (or the transmission interface circuit 58 therein) according to the one or more communications specifications for the memory device 100. Similarly, the transmission interface circuit 58 may conform to the one or more communications specifications, and may perform communications with the memory device 100 (or the transmission interface circuit 118 therein) according to the one or more communications specification for the host device 50.

In this embodiment, the host device 50 may transmit a plurality of host commands corresponding to logical addresses to the memory controller 110, to indirectly access the NV memory 120 within the memory device 100. The memory controller 110 receives the plurality of host commands and the logical addresses, and translates the plurality of host commands into memory operating commands (which may be referred to as operating commands, for brevity), respectively, and further controls the NV memory 120 with the operating commands to perform reading or writing/programing upon the memory units or data pages of specific physical addresses within the NV memory 120, where the physical addresses can be associated with the logical addresses. For example, the memory controller 110 may generate or update at least one logical-to-physical (L2P) address mapping table to manage the relationships between the physical addresses and the logical addresses. The NV memory 120 may store a global L2P address mapping table 120AM for the memory controller 110 to control the memory device 100 to access data in the NV memory 120, but the present invention is not limited thereto.

For better comprehension, the global L2P address mapping table 120AM may be located in a predetermined region within the NV memory element 122-1, such as a system region, but the present invention is not limited thereto. For example, the global L2P address mapping table 120AM may be divided into a plurality of local L2P address mapping tables, and the plurality of local L2P address mapping tables may be stored in one or more of the NV memory elements 122-1, 122-2, . . . , and 122-N_{E}, and more particularly, may be stored in the NV memory elements 122-1, 122-2, . . . , and 122-N_{E}, respectively. When there is a need, the memory controller 110 may load at least one portion (e.g., a portion or all) of the global L2P address mapping table 120AM into the RAM 116 or other memories. For example, the memory controller 110 may load a local L2P address mapping table among the plurality of local L2P address mapping tables into the RAM 116 to be a temporary L2P address mapping table 116AM, for accessing data in the NV memory 120 according to the local L2P address mapping table which is stored as the temporary L2P address mapping table 116AM, but the present invention is not limited thereto. The memory controller 110 may generate or update address mapping information in the temporary L2P address mapping table 116AM, and update the global L2P address mapping table 120AM according to the latest address mapping information in the temporary L2P address mapping table 116AM.

In addition, the above-mentioned at least one NV memory element (e.g., the one or more NV memory elements such as {122-1, 122-2, . . . , 122-N_{E}}) may include a plurality of blocks {BLK}, wherein the minimum unit that the memory controller 110 may perform operations of erasing data upon the NV memory 120 may be a block, and the minimum unit that the memory controller 110 may perform operations of writing data upon the NV memory 120 may be a page, but the present invention is not limited thereto. For example, any NV memory element 122-n (where “n” may represent any integer in the interval [1, N_{E}]) within the NV memory elements 122-1, 122-2, . . . , and 122-N_{E} may include multiple blocks, and a block among the multiple blocks may include and record a specific number of pages, wherein the memory controller 110 may access a certain page of a certain block among the multiple blocks according to a block address and a page address. In some examples, the NV memory element 122-n may include multiple planes, a plane among the multiple planes may include multiple blocks, and a block among the multiple blocks may include and record a specific number of pages, wherein the memory controller 110 may access a certain page of a certain block within a certain plane among the multiple planes according to a plane address, a block address, and a page address.

According to some embodiments, the memory controller 110 may configure any block BLK among the blocks {BLK} as a single level cell (SLC) block, for performing storage of 1 bit per memory cell, but the present invention is not limited thereto. The memory controller 110 may configure the block BLK as an X-level cell (XLC) block, for performing storage of X bits per memory cell, wherein X may be a positive integer. For example, when X=1, the XLC block may represent the SLC block. In some examples, when X>1, the XLC block may represent any of a multiple level cell (MLC) block (e.g., a double level cell (DLC) block), a triple level cell (TLC) block, and a quadruple level cell (QLC) block. The NV memory 120 may be implemented by means of three-dimensional (3D) flash memory technology to increase a predetermined upper limit X_{MAX} of the parameter X, in order to allow the memory controller 110 to the memory device 100 to have a larger available storage capacity, but the present invention is not limited thereto. When the memory device 100 is able to store a large amount of data (e.g., user data), key factors that affect the overall performance of the electronic device 10 may include:
(1) Factor I: during data access, in response to multiple commands {CMD} from the host device 50, the memory controller 110 can rapidly access the NV memory 120 for the host device 50; and
(2) Factor II: during data access, the host device 50 can smoothly complete the processing of the commands {CMD}.

For example, the memory controller 110 may operate according to at least one control scheme in order to rapidly access the NV memory 120 for the host device 50 in response to the commands {CMD} during data access, and dynamically adjust configuration of the memory device 100 to optimize host side access control of the host device 50 regarding the commands {CMD}. More particularly, the memory controller 110 may dynamically adjust at least one configuration of at least one component within the memory controller 110 (e.g., the transmission interface circuit 118) in order to minimize a total time of the host side access control of the host device 50 regarding the commands {CMD}, for ensuring the overall performance of the electronic device 10. When there is a need, the memory controller 110 may dynamically adjust at least one parameter of the transmission interface circuit 118 (e.g., the multiple parameters of the bottom layer circuit 118B) by at least one upper layer circuit within the memory controller 110 (e.g., the parameter controller 118P), in order to perform access control in response to the latest state of the electronic device 10 (or the host device 50 and/or the memory device 100 therein), for accelerating completion of the host side access control regarding the commands {CMD} and improving the throughput of the memory device 100 regarding data access, wherein the at least one component may include the transmission interface circuit 118, and the at least one configuration may include a set of configurations of the bottom layer circuit 118B within the transmission interface circuit 118 (e.g., configurations defined or determined by the multiple parameters of the bottom layer circuit 118B), but the present invention is not limited thereto. In some examples, the at least one upper layer circuit may include a combination or one of the microprocessor 112 and/or the parameter controller 118P.

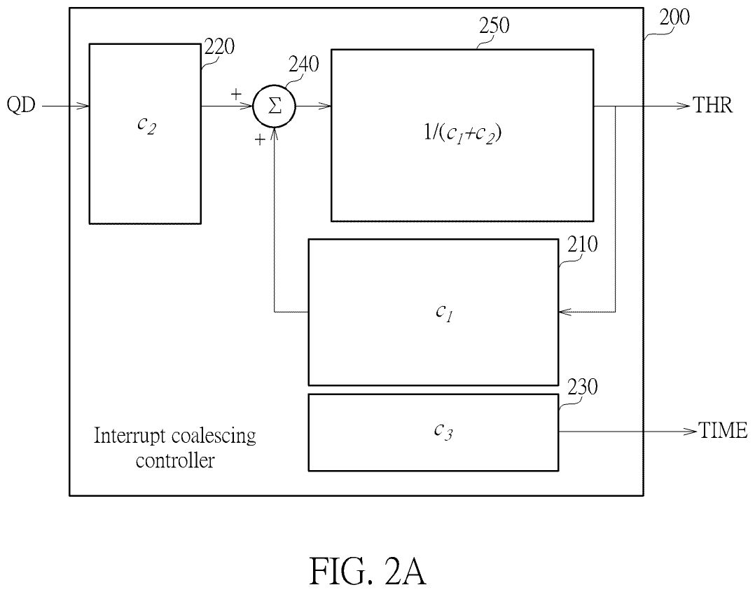

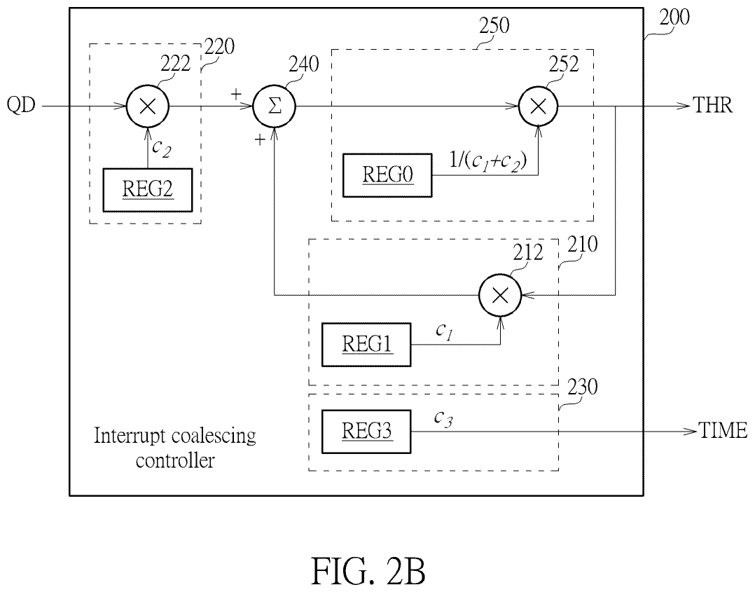

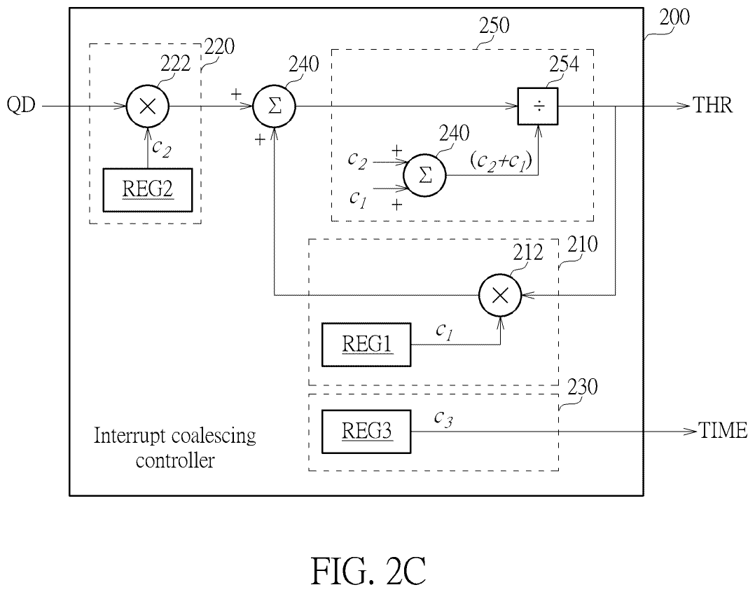

FIG. 2A is a diagram illustrating an interrupt coalescing controller 200 according to an embodiment of the present invention, wherein the parameter controller 118P shown in FIG. 1 may be implemented by the interrupt coalescing controller 200, and the multiple parameters of the bottom layer circuit 118B may include multiple aggregation parameters (e.g., an aggregation threshold THR and an aggregation time TIME. The interrupt coalescing controller 200 may include a first arithmetic processing circuit 210, a second arithmetic processing circuit 220, a parameter generating circuit 230, an adder 240, and a third arithmetic processing circuit 250, for processing with a first gain GAIN1 (e.g., GAIN1=c₁), processing with a second gain GAIN2 (e.g., GAIN2=c₂), generating the aggregation time TIME (e.g., TIME=c₃), performing at least one sum operation, and processing with a third gain GAIN3 (e.g., GAIN3=(1/(c₁+c₂))) to generate the aggregation threshold THR, respectively (labeled as “c₁”, “c₂”, “c₃”, “Σ”, “1/(c+c₂)”, respectively, in FIG. 2A for brevity). Under control of the microprocessor 112, the memory controller 110 may obtain a queue depth QD from the bottom layer circuit 118B for inputting into the first arithmetic processing circuit 210. For example, host side parameters of the host device 50 may include the queue depth QD, and the memory controller 110 may obtain at least one portion of the host side parameters (e.g., the queue depth QD) from the host device 50 through the bottom layer circuit 118B.

When the circuit architecture shown in FIG. 2A performs a k^{th} processing, related operations may include:
(1) the first arithmetic processing circuit 210 may apply the first gain GAIN1 (e.g., GAIN1=c₁) to a previous output of the third arithmetic processing circuit 250 (e.g., an output of a (k−1)^{th} processing) to generate a first processing result, for being input into the adder 240;
(2) the second arithmetic processing circuit 220 may apply the second gain GAIN2 (e.g., GAIN2=c₂) to the queue depth QD to generate a second processing result, for being input into the adder 240;
(3) the adder 240 may perform a sum operation upon the first processing result and the second processing result to generate a sum result, for being input into the third arithmetic processing circuit 250;
(4) the third arithmetic processing circuit 250 may apply the third gain GAIN3 (e.g., GAIN3=(1/(c₁+c₂))) to the sum result to generate a current output (e.g., an output of the k^{th} processing), and output the current output as the aggregation threshold THR; and
(5) the parameter generating circuit 230 may generate the aggregation time TIME according to a predetermined value c₃ (e.g., TIME=c₃), and output the aggregation time TIME;
wherein “k” may represent an integer (e.g., a positive integer) for indicating the number of times the memory controller 110 scans or detects the queue depth QD, but the present invention is not limited thereto. For example, according to zero-based numbering, “k” may represent a non-negative integer. For another example, “k” may represent any integer, and a series of time points {t(k)} may include time points {. . . , t(−1), t(0), t(1), . . . }, wherein the k^{th} processing and the (k−1)^{th} processing may be replaced by processing at a time point t(k) and processing at a time point t(k−1), respectively. In addition, the queue depth DQ may represent a queue depth QD(i) of any queue circuit QC(i) among multiple queue circuits {QC(i)} of the host device 50 for indicating the queue depth of the queue circuit QC(i). The aggregation threshold THR and the aggregation time TIME may represent the aggregation threshold THR and the aggregation time TIME corresponding to the queue circuit QC(i) (or a queue identifier (ID) QUEUE_ID(i) thereof), respectively, in order for the memory controller 110 to perform related device side access control. Since the queue circuits {QC(i)} are located in the host device 50 (not the memory device 100), the memory controller 110 may perform dynamic configuration optimization according to respective queue IDs {QUEUE_ID(i)} of the queue circuits {QC(i)}, and more particularly, may obtain the queue depth QD(i) corresponding to the queue ID QUEUE_ID(i) from the bottom layer circuit 118B, and set the aggregation threshold THR and the aggregation time TIME corresponding to the queue ID QUEUE_ID(i) in order to perform the device side access control corresponding to the queue circuit QC(i).

FIG. 2B is a diagram illustrating an example of implementation details of the circuit architecture shown in FIG. 2A, wherein the circuit architecture may be implemented by multiple register circuits {REG} (e.g., multiple register circuits REG0, REG1, REG2, and REG3) and multiple arithmetic units (e.g., multiple multipliers 212, 222, and 252 and the adder 240), and any register circuit among the register circuits {REG} may include at least one register. Under control of the microprocessor 112, the memory controller 110 may respectively load a set of predetermined values (1/(c₁+c₂)), c₁, c₂, and c₃ from the NV memory 120 into the register circuits REG0, REG1, REG2, and REG3 in advance, wherein a production tool may be arranged to control the memory controller 110 to store the set of predetermined values (1/(c₁+c₂)), c₁, c₂, and c₃ into the predetermined region within the NV memory 120 (e.g., the system region) during a production phase of the memory device 100, but the present invention is not limited thereto. For example, the memory controller 110 may obtain respective latest values of the set of predetermined values (1/(c₁+c₂)), c₁, c₂, and c₃ from another source (e.g., the host device 50), for updating the set of predetermined values (1/(c₁+c₂)), c₁, c₂, and c₃ in the predetermined region. For another example, the set of predetermined values (1/(c₁+c₂)), c₁, c₂, and c₃ may also be stored in the RAM 116 or any type of memory.

As shown in FIG. 2B, the first arithmetic processing circuit 210 may output the predetermined value c₁ to the multiplier 212 by the register circuit REG1, and apply the first gain GAIN1 (e.g., GAIN1=c₁) to the previous output of the third arithmetic processing circuit 250 by the multiplier 212 to generate the first processing circuit. The second arithmetic processing circuit 220 may output the predetermined value c₂ to the multiplier 222 by the register circuit REG2, and apply the second gain GAIN2 (e.g., GAIN2=c₂) to the queue depth QD by the multiplier 222 to generate the second processing circuit. The parameter generating circuit 230 may output the predetermined value c₃ by the register circuit REG3. The third arithmetic processing circuit 250 may output the predetermined value (1/(c₁+c₂)) to the multiplier 252 by the register circuit REG0, and apply the third gain GAIN3 (e.g., GAIN3=(1/(c₁+c₂))) to the sum result by the multiplier 252 to generate the current output.

FIG. 2C is a diagram illustrating another example of implementation details of the circuit architecture shown in FIG. 2A, wherein the circuit architecture may be implemented by multiple register circuits {REG} (e.g., multiple register circuits REG1, REG2, and REG3) and multiple arithmetic units (e.g., multiple multipliers 212 and 222, a divider 254, and multiple adders 240 and 256). Compared with the example shown in FIG. 2B, the divider 254 and the adder 256 in the example shown in FIG. 2C may replace the multiplier 252 and the register circuit REG0, respectively. The third arithmetic processing circuit 250 may perform a sum operation upon the predetermined values c₁ and c₂ by the adder 256 to generate a sum (c₁+c₂), and perform a division operation upon the sum result generated by the adder 240 according to the sum (c₁+c₂), and more particularly, may divide the sum result from the adder 240 by the sum (c₁+c₂) to generate the current output (e.g., the output of the k^{th} processing), and output the current output as the aggregation threshold THR.

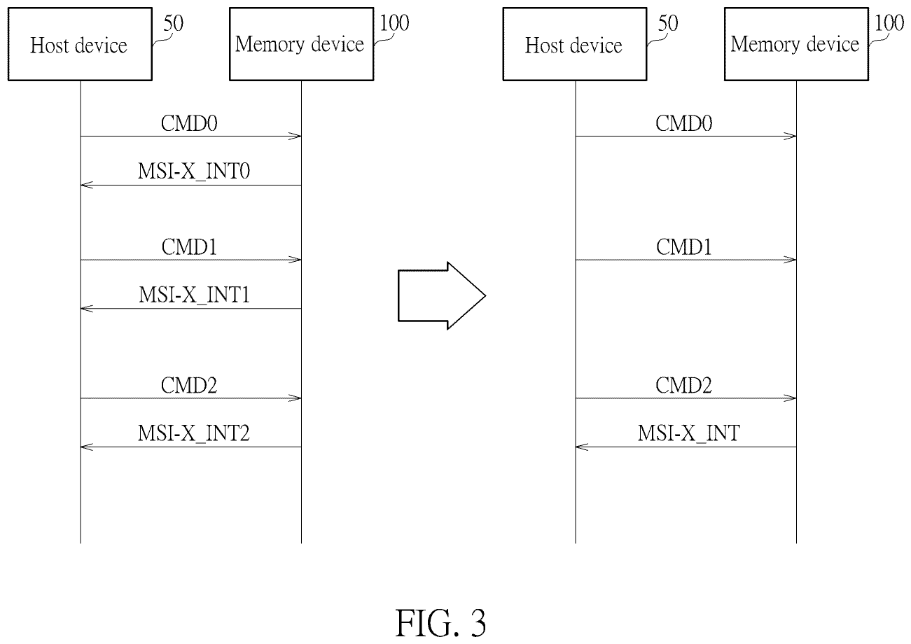

FIG. 3 illustrates, in the right half thereof, a dynamically optimized access control scheme according to an embodiment of the present invention, wherein a non-optimized access control scheme is illustrated in the left half of FIG. 3 for better comprehension. For example, the memory controller 110 may set TIME=0 when operating according to the non-optimized access control scheme. Under this situation, when a command CMD is received, the memory controller 110 may access the NV memory 120 according to the command CMD, and return a message-signaled interrupt (MSI) MSI-X_INT. The command CMD may represent any command among commands CMD0, CMD1, and CMD2 shown in the left half of FIG. 3, and the MSI MSI-X_INT may represent a corresponding MSI among MSIs MSI-X_INT0, MSI-X_INT1, and MSI-X_INT2 shown in the left half of FIG. 3 (e.g., an MSI corresponding to the command).

When there is a need, the memory controller 110 may operate according to the dynamically optimized access control scheme to perform the above-mentioned dynamic configuration optimization, and more particularly, may dynamically adjust the aggregation threshold THR and the aggregation time TIME in order to minimize the total time of the host side access control of the host device 50 regarding the commands {CMD}, such that the host device 50 can smoothly complete the processing of the commands {CMD} during data access, thereby ensuring the overall performance of the electronic device 10. For example, the commands {CMD} may include commands {CMD0, CMD1, CMD2}. When any command CMD among the commands {CMD} is received, the memory controller 110 may access the NV memory 120 according to the command CMD. As shown in the right half of FIG. 3, based on the dynamic configuration optimization, the memory controller 110 may return an MSI MSI-X_INT corresponding to the commands {CMD0, CMD1, CMD2}, rather than return any MSI MSI-X_INT that only corresponds to a single command CMD.

In addition, each of the MSIs MSI-X_INT, MSI-X_INT0, MSI-X_INT1, and MSI-X_INT1=2 may be implemented by an extended MSI (MSI-X), but the present invention is not limited thereto. For example, each of the MSIs MSI-X_INT, MSI-X_INT0, MSI-X_INT1, and MSI-X_INT1=2 may be implemented by a standard MSI or a non-extended MSI. For another example, each of the MSIs MSI-X_INT, MSI-X_INT0, MSI-X_INT1, and MSI-X_INT1=2 may be implemented by an interrupt message, for emulating legacy interrupt (e.g., interrupt on physical interrupt pins).

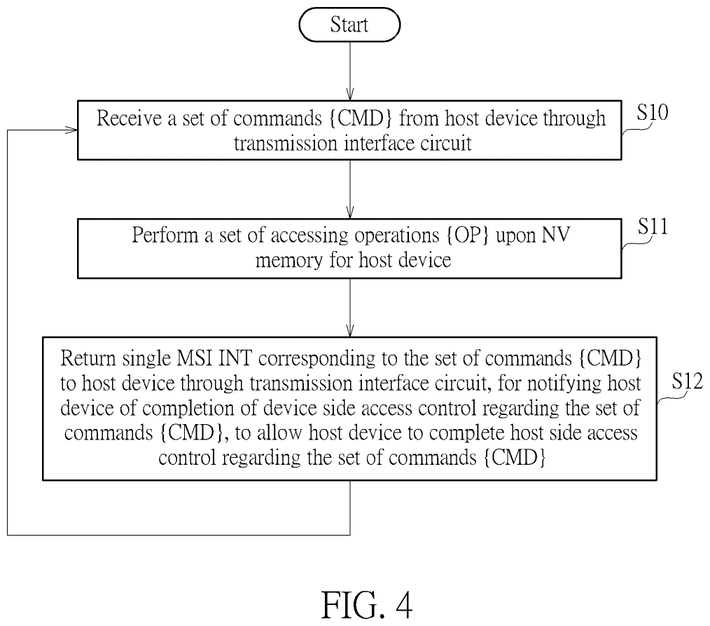

FIG. 4 is a flow chart of a method for performing access control of a memory device with aid of interrupt management according to an embodiment of the present invention.

In Step S10, the memory controller 110 may receive a set of commands {CMD} (e.g., the commands {CMD0, CMD1, CMD2}) from the host device 50 through the transmission interface circuit 118, wherein a command count CNT_CMD of the set of commands {CMD} may be greater than one, and any command CMD among the set of commands {CMD} may indicate a request for accessing the memory device 100. For example, the set of commands {CMD} may include at least one read command CMD_{READ} (e.g., a set of read commands {CMD_{READ}}). In another example, the set of commands {CMD} may include at least one write command CMD_{WRITE} (e.g., a set of write commands {CMD_{WRITE}}). In some examples, the set of commands {CMD} may include a combination or one of the at least one read command CMD_{READ} and the at least one write command CMD_{WRITE}.

In Step S11, in response to the set of commands {CMD}, the memory controller 110 may perform a set of accessing operations {OP} upon the NV memory 120 for the host device 50, wherein the set of accessing operations {OP} may include a corresponding accessing operation OP performed by the memory controller 110 in response to the command CMD among the set of commands {CMD}. For example, if the command CMD among the set of commands {CMD} is a read command CMD_{READ}, the memory controller 110 may read store data DATA_{STORED} from the NV memory 120 as read data DATA_{READ} for transmitting to the host device 50. In another example, if the command CMD among the set of commands {CMD} is a write command CMD_{WRITE}, the memory controller 110 may write write data DATA_{WRITE} from the host device 50 into the NV memory 120.

In Step S12, in response to the set of commands {CMD}, the memory controller 110 may return a single MSI INT (e.g., the MSI MSI-X_INT) corresponding to the set of commands {CMD} to the host device 50 by the transmission interface circuit 118, for notifying the host device 80 of completion of device side access control of the memory device 100 regarding the set of commands {CMD}, to thereby allow the host device 50 to complete host side access control of the host device 50 regarding the set of commands {CMD}. For example, the single MSI INT may be implemented by one of the standard/non-extended MSI and the extended MSI.

As shown in FIG. 4, the memory controller 110 may execute a loop including Steps S10, S11, and S12 multiple times. For example, in the commands {CMD} (e.g., the commands {CMD0, CMD1, CMD2, . . . }) transmitted from the host device 50 to the memory device 100, the set of commands {CMD} may represent a first set of commands {CMD} among multiple sets of commands {{CMD}, . . . , {CMD}}, and the multiple sets of commands {{CMD}, . . . , {CMD}} may include the first set of commands {CMD} (e.g., commands {CMD0, CMD1, CMD2}) and at least one other set of commands {CMD} (e.g., commands {CMD3, CMD4, . . . }, such as a second set of commands {CMD}). In addition, the set of accessing operations {OP} may represent a first set of accessing operations {OP} among multiple sets of accessing operations {{OP}, . . . , {OP}}, and the multiple sets of accessing operations {{OP}, . . . , {OP}} may include the first set of accessing operations {OP} and at least one other set of accessing operations {OP} (e.g., a second set of accessing operations {OP}). Additionally, the single MSI INT may represent a first MSI INT corresponding to the first set of commands {CMD} among multiple MSIs {INT}, and the multiple MSIs {INT} may include the first MSI INT and at least one other MSI INT (e.g., a second MSI INT). When this loop is executed another time, related operations may include:
(1) in Step S10, the memory controller 110 may receive another set of commands {CMD} (e.g., the second set of commands {CMD}) from the host device 50 through the transmission interface circuit 118, wherein a command count CNT_CMD of the set of commands {CMD} may be greater than one, and any command CMD among the set of commands {CMD} may indicate a request for accessing the memory device 100;
(2) in Step S11, in response to the set of commands {CMD} (e.g., the second set of commands {CMD}), the memory controller 110 may perform another set of accessing operations {OP} (e.g., the second set of accessing operations {OP}) upon the NV memory 120 for the host device 50, wherein the set of accessing operations {OP} may include a corresponding accessing operation OP performed by the memory controller 101 in response to the command CMD among the set of commands {CMD}; and
(3) in Step S12, in response to the set of commands {CMD} (e.g., the second set of commands {CMD}), the memory controller 110 may return a single MSI INT (e.g., the second MSI INT) corresponding to the set of commands {CMD} to the host device 50 by the transmission interface circuit 118, for notifying the host device 50 of completion of device access control of the memory device 100 regarding the set of commands {CMD}, to thereby allow the host device 50 to complete host side access control of the host device 50 regarding the set of commands {CMD}.

For better comprehension, the method may be illustrated with the working flow shown in FIG. 4, but the present invention is not limited thereto. According to some embodiments, one or more steps may be added, deleted, or changed in the working flow shown in FIG. 4. For example, the memory controller 110 may dynamically perform access control mode switching, to selectively operate according to the dynamically optimized access control scheme or the non-optimized access control scheme. In addition, the memory controller 110 may dynamically adjust configuration of the memory device 100 to optimize the host side access control of the host device 50 regarding the set of commands {CMD}, and more particularly, may dynamically adjust at least one configuration of at least one component within the memory controller 110 (e.g., the transmission interface circuit 118), in order to minimize the total time of the host side access control of the host device 50 regarding the set of commands {CMD}, such that the host device 50 can smoothly complete the processing regarding the set of commands {CMD} during data access, thereby ensuring the overall performance of the electronic device 10. In addition, the memory controller 110 may dynamically adjust at least one parameter (e.g., the multiple parameters of the bottom layer circuit 118B) of the transmission interface circuit 118 by at least one upper layer circuit within the memory controller 110 (e.g., the microprocessor 112 and/or the parameter controller 118P) in order to perform access control in response to the latest state of the electronic device 10 (or the host device 50 and/or the memory device 100 therein), for accelerating completion of the host side access control regarding the set of commands {CMD} and improving the throughput of the memory device 100 regarding data access. More particularly, the at least one parameter may include the multiple aggregation parameters (e.g., the aggregation threshold THR and the aggregation time TIME), and the memory controller 110 may dynamically adjust the multiple aggregation parameters according to at least one predetermined rule for accelerating completion of the host side access control regarding the set of commands {CMD}, and may optimize timing of the multiple MSIs {INT} with respect to the multiple sets of commands {{CMD}, . . . , {CMD}} by dynamically adjusting the multiple aggregation parameters. For brevity, further descriptions for these embodiments are not repeated in detail here.

TABLE 1

| Bit | Illustration |
|---|---|
| 31:16 | Reserve |
| 15:08 | Aggregation time (TIME): a recommended maximum time that |
| | a controller can delay an interrupt due to interrupt |
| | coalescing is specified in units of 100 microseconds (μs). |
| | The controller can apply this time per interrupt vector or |
| | across all interrupt vectors. A value of 0 h corresponds to |
| | no delay. A reset value of this setting is 0 h. |
| 07:00 | Aggregation threshold (THR): a recommended minimum number |
| | of completion queue entries to aggregate per interrupt |
| | vector is specified before the host is signaled. This is |
| | a 0's based value. A reset value of this setting is 0 h. |

Table 1 illustrates an example of a double word (Dword) in a packet from the host device 50, wherein the field of bits [31:16] may be a reserved field (labeled as “Reserve” in Table 1 for brevity), and the host device 50 may use the field “Aggregation time” of bits [15:08] and the field “Aggregation threshold” of the bits [07:00] (labeled as “TIME” and “THR” in Table 1, respectively, for brevity) to specify respective recommended values of the aggregation time TIME and the aggregation threshold THR, but the present invention is not limited thereto. The memory controller 110 may ignore the Dword (or the respective recommended values of the aggregation time TIME and the aggregation threshold THR contained in the Dword) specified by the host device 50, and more particularly, may determine the aggregation time TIME and the aggregation threshold THR by itself, rather than fix the aggregation time TIME and the aggregation threshold THR to the recommended values specified by the host device 50. By avoiding fixing the aggregation time TIME and the aggregation threshold THR to the recommended values specified by the host device 50, the memory controller 110 can properly perform access control of the memory device 100. For example, the memory controller 110 may dynamically adjust one or more aggregation parameters among the multiple aggregation parameters (e.g., the aggregation time TIME and the aggregation threshold THR) according to the at least one predetermined rule, in order to accelerate completion of the host side access control regarding the set of commands {CMD} and optimize timings of the multiple MSIs {INT} with respect to the multiple sets of commands {{CMD}, . . . , {CMD}}.

Some details regarding the dynamic adjustment of the multiple aggregation parameters are further illustrated as follows. When the queue depth DQ is equal to a smaller value (e.g. a value lower than four), it may be difficult to set the aggregation threshold THR appropriately. More particularly, it may be difficult to find an appropriate value for setting the aggregation threshold THR. For example, the number of commands {CMD} received by the memory device 100 at one time may be small, and the processing speed of the memory device 100 may be quite fast. Under this situation, if THR>QD, and the memory device 100 accumulates these commands {CMD} within a time interval without sending an interrupt INT, there will soon be no new command CMD available for processing, such that there is no new command CMD available for processing until the cumulative time exceeds the aggregation time TIME (or its current setting value), which reduces the overall performance. In another example, if THR<QD or the aggregation time TIME (or its current setting value) is quite small, the benefit of setting the aggregation threshold THR may not be significant. In addition, under a condition that the queue depth QD is large, since the payload on the PCIe bus is already close to full, turning on the interrupt coalescing at this moment may not be helpful in improving the overall performance, wherein the bottleneck of the related processing should be in the memory device 100 rather than the host device 50, and more particularly, should not be related to the performance of the host device 50.

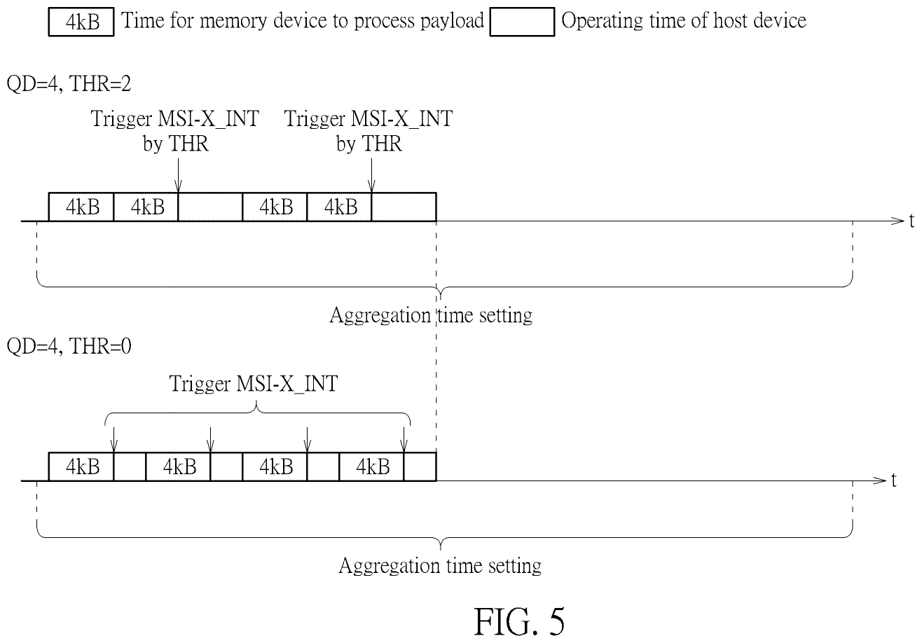

FIG. 5-FIG. 8 illustrate various examples of timing diagrams regarding access control, wherein the horizontal axis may represent a time t, the downward arrows respectively indicate the time points when the memory controller 110 returns the MSIs {MSI-X_INT} to the host device 50, and the length of the time interval indicated by the braces below the horizontal axis may be equal to the current setting value of the aggregation time TIME (labeled as “Aggregation time setting” for brevity). For better comprehension, assume that respective payloads of the commands {CMD} received by the memory controller 110 from the host device 50 have the same size (e.g., 4 kilobytes (KB)), and the memory controller 110 may take the same amount of time to process these payloads (labeled as “4 kB” for brevity), but the present invention is not limited thereto.

As shown in the upper half of FIG. 5, assume that QD=4 and THR=2. The number of commands {CMD} received by the memory controller 110 at one time may be quite small (e.g., four commands {CMD}, and the memory controller 110 may rapidly process these commands {CMD}. The memory controller 110 may immediately return a first MSI MSI-X_INT to the host device 50 after the first two payloads are processed, and may immediately return a second MSI MSI-X_INT to the host device 50 after the last two payloads are processed, wherein these MSIs {MSI-X_INT} are triggered by trigger events corresponding to the aggregation threshold THR (e.g., events where the aggregation threshold THR is achieved; labeled as “Trigger MSI-X_INT by THR” for brevity). The host device 50 may immediately perform host side access control regarding the first two commands {CMD} after the first MSI MSI-X_INT is received, and may immediately perform host side access control regarding the last two commands {CMD} after the second MSI MSI-X_INT is received. Before a time indicated by the current setting value of the aggregation time TIME expires, both the host device 50 and the memory device 100 may be in an idle state.

As shown in the lower half of FIG. 5, assume that QD=4 and THR=0. The number of commands {CMD} received by the memory controller 110 at one time may be four, and the memory controller 110 may rapidly process these commands {CMD}. After receiving a current command CMD among the four commands {CMD}, the memory controller 110 may process a current payload corresponding to the current command CMD, and immediately return a corresponding MSI MSI-X_INT to the host device 50. The host device 50 may immediately perform host side access control regarding the current command CMD after the MSI MSI-X_INT is received. Before a time indicated by the current setting value of the aggregation time TIME expires, both the host device 50 and the memory device 100 may be in an idle state.

In the examples shown in FIG. 5, a ratio of the time the host device 50 and the memory device 100 are in the idle state to the time indicated by the current setting value of the aggregation time is quite large. AS a result, under a condition that the queue depth QD is small, the benefit of setting the aggregation threshold THR may not be significant.

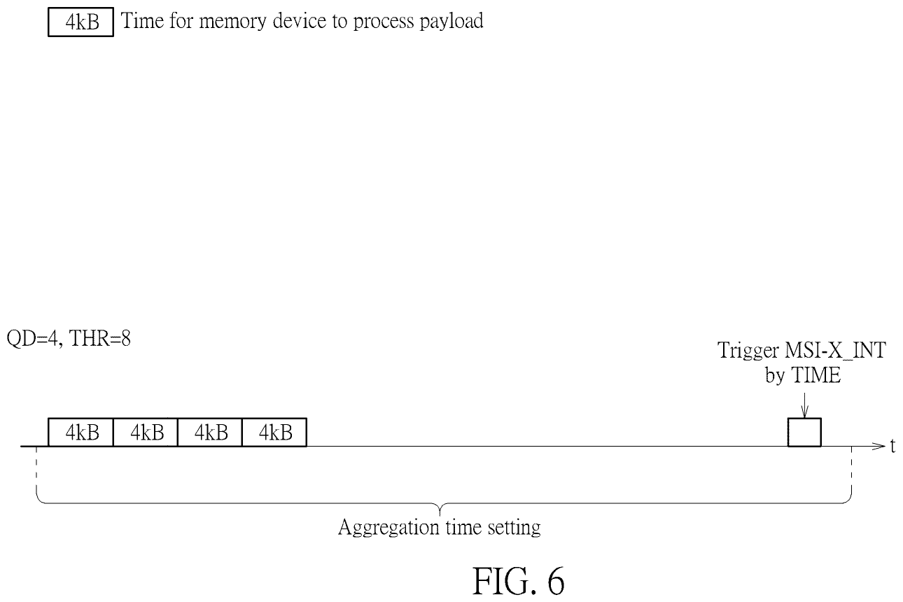

As shown in FIG. 6, assume that QD=4 and THR=8. The number of commands {CMD} received by the memory controller 110 at one time may be four, and the memory controller 110 may rapidly process these commands {CMD}. After receiving a current command CMD among the four commands {CMD}, the memory controller 110 may process a current payload corresponding to the current command CMD, but may not immediately return any MSI MSI-X_INT to the host device 50. Before a time indicated by the current setting value of the aggregation time TIME expires, the memory controller 110 may return an MSI MSI-X_INT to the host device 50, wherein the MSI MSI-X_INT is triggered by a trigger event corresponding to the aggregation threshold THR (e.g., an event where the time indicated by the current setting value of the aggregation time TIME is about to expire; labeled as “Trigger MSI-X_INT by TIME” for brevity).

In the example shown in FIG. 6, a ratio of the time the memory device 100 is in the idle state to the time indicated by the current setting value of the aggregation time is quite large, and the host device 50 waits until receiving the MSI MSI-X_INT. As a result, improperly setting the aggregation threshold THR may reduce the payload per unit time and thereby reduce the performance.

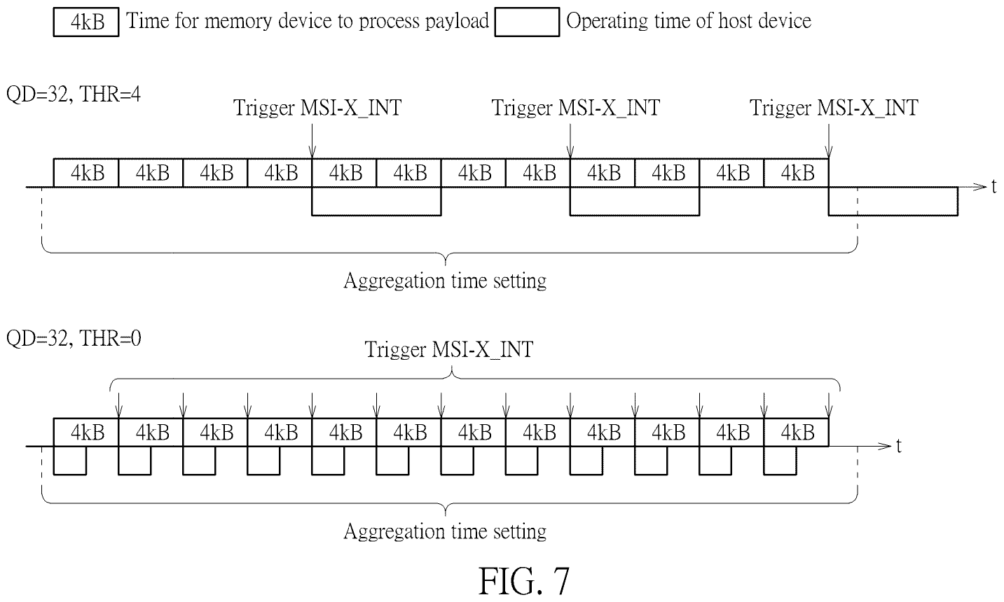

As shown in the upper half of FIG. 7, assume that QD=32 and THR=0. The memory controller 11 may receive twelve commands {CMD} and process these commands {CMD} successively. After receiving a current command CMD among the twelve commands {CMD}, the memory controller 110 may process a current payload corresponding to the current command CMD. In addition, the memory controller 110 may immediately return a first MSI MSI-X_INT to the host device 50 after the first four payloads corresponding to the first four commands {CMD} are processed, immediately return a second MSI MIS-X_INT to the host device 50 after four subsequent payloads corresponding to four subsequent commands {CMD} are processed, and immediately return a third MSI MSI-X_INT to the host device 50 after the last four payloads corresponding to the last four commands {CMD} are processed. The host device 50 may immediately perform host side access control regarding the first four commands {CMD} after the first MSI MSI-X_INT is received, immediately perform host side access control regarding the four subsequent commands {CMD} after the second MSI MSI-X_INT is received, and immediately perform host side access control regarding the last four commands {CMD} after the third MSI MSI-X_INT is received. Before a time indicated by the current setting value of the aggregation time TIME expires, the memory device 100 processes these payloads for almost an entire period of time, and a large portion of the total operating time of the host device 50 can be hidden in the time the memory device 100 processes these payloads.

As shown in the lower half of FIG. 7, assume that QD=32 and THR=0. The memory controller 11 may receive twelve commands {CMD} and process these commands {CMD} successively. After receiving a current command CMD among the twelve commands {CMD}, the memory controller 110 may process a current payload corresponding to the current command CMD, and immediately return a corresponding MSI MSI-X_INT to the host device 50. The host device 50 may immediately perform host side access control regarding the current command CMD after the corresponding MSI MSI-X_INT is received. Before a time indicated by the current setting value of the aggregation time TIME expires, the memory device 100 processes these payloads for almost an entire period of time, and a greater portion of the total operating time of the host device 50 can be hidden in the time the memory device 100 processes these payloads.

In these examples shown in FIG. 7, the memory device 100 processes the payloads for almost an entire period of time. When the queue depth DQ is large, since the number of commands in the queue may be quite large, setting the aggregation threshold THR as a middle value or a smaller value within a predetermined value range can make the operating time of the host device 50 (e.g., a process time of host side access control regarding a certain command CMD) hidden in the time the memory device 100 processes a certain payload (e.g., a payload corresponding to another command CMD).

When the queue depth QD is not too large or too small, the memory controller 110 may dynamically adjust one or more aggregation parameters among the multiple aggregation parameters (e.g., the aggregation threshold THR and the aggregation time TIME), in order to improve the overall performance.

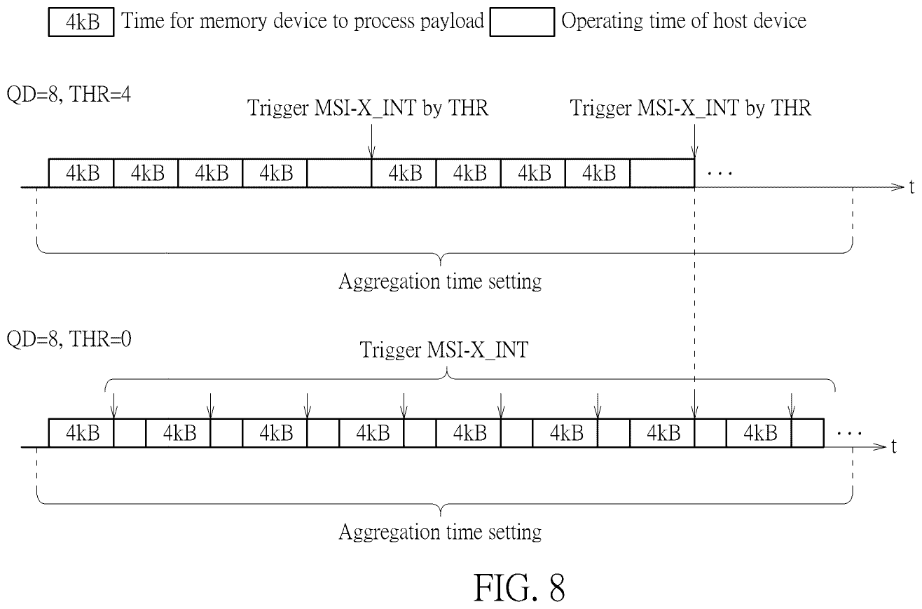

As shown in the upper half of FIG. 8, assume that QD=8 and THR=4. The memory controller 11 may receive eight commands {CMD} and process these commands {CMD} successively. After receiving a current command CMD among the eight commands {CMD}, the memory controller 110 may process a current payload corresponding to the current command CMD. In addition, the memory controller 110 may immediately return a first MSI MSI-X_INT to the host device 50 after the first four payloads corresponding to the first four commands {CMD} are processed, and immediately return a second MSI MSI-X_INT to the host device 50 after the last four payloads corresponding to the last four commands {CMD} are processed, wherein these MSIs {MSI-X_INT} are triggered by trigger events corresponding to the aggregation threshold THR (e.g., events where the aggregation threshold THR is achieved; labeled as “Trigger MSI-X_INT by THR” for brevity). The host device 50 may immediately perform host side access control regarding the first four commands {CMD} after the first MSI MSI-X_INT is received, and immediately perform host side access control regarding the last four commands {CMD} after the second MSI MSI-X_INT is received.

As shown in the lower half of FIG. 8, assume that QD=8 and THR=0. The memory controller 11 may receive four commands {CMD} and process these commands {CMD} successively. After receiving a current command CMD among the four commands {CMD}, the memory controller 110 may process a current payload corresponding to the current command CMD, and immediately return a corresponding MSI MSI-X_INT to the host device 50. The host device 50 may immediately perform host side access control regarding the current command CMD after the corresponding MSI MIS-X_INT is received.

In these examples shown in FIG. 8, when the queue depth QD falls in a first predetermined range, the memory controller 110 may dynamically adjust the aggregation threshold THR and the aggregation time TIME to improve the overall performance, wherein the first predetermined range may represent a predetermined interval of the queue depth QD (e.g., an interval [8, 32]) that can be regarded as an interval of a medium queue depth, but the present invention is not limited thereto. For example, the predetermined interval of the queue depth QD may vary. In some examples, when starting to process input/output (I/O) commands {CMD} (e.g., the read commands {CMD_{READ}} and/or the write commands {CMD_{WRITE}}), the memory controller 110 (or the microprocessor 112 running a related program code) may periodically detect the queue depth QD of at least one queue circuit of the host device 50 (e.g., the queue circuit QD(i) of the queue circuit QC(i)), and more particularly, may detect the queue depth QD(i) corresponding to the queue ID QUEUE_ID(i) by an interrupt service routine (ISR) controlled by a central processing unit (CPU) timer within the microprocessor 112, and set the aggregation time TIME(i) to be equal to a predetermined time length (e.g., the predetermined value c₃) and set an initial value of the aggregation threshold THR(i) to be equal to half of the queue length QD(i), for starting to dynamically adjust the aggregation threshold THR(i).

For better comprehension, assume that the queue depths {QD(i)} respectively corresponding to the queue IDs {QUEUE_ID(i)} are equal to each other. If the queue depths {QD(i)} fall in the first predetermined range, the memory controller 110 may operate according to the dynamically optimized access control scheme, in order to adjust the aggregation threshold THR and the aggregation time TIME; otherwise, the memory controller 110 may operate according to the non-optimized access control scheme, in order to avoid performing any interrupt coalescing under a condition that the queue depths {QD(i)} are too large or too small. The memory controller 110 may control any MSI MSI-X_INT among all MSIs {MSI-X_INT} to be triggered by trigger events corresponding to the aggregation threshold THR (e.g., events where the aggregation threshold THR is achieved), rather than be triggered by trigger events corresponding to the aggregation time TIME (e.g., events where the aggregation time TIME is achieved), in order to avoid any performance reduction caused by the trigger events corresponding to the aggregation time TIME. Take QD=8 and THR=4 as an example for dynamic setting of the aggregation threshold THR. The memory controller 110 may immediately return an MSI MSI-X_INT to the host device 50 after the processing of four payloads corresponding to four commands {CMD} is completed, such that the host device performs host side access control regarding the four commands {CMD}, starts to process the next four payloads corresponding to the next four commands {CMD}, and the rest may be deduced by analogy. For example, as shown in the upper half of FIG. 8, when the processing of the 8^{th} payload corresponding to the 8^{th} command CMD is completed, before the second MSI MSI-X_INT is returned to the host device 50, it can be expected that the host device 50 will transmit the 9^{th} to the 12^{th} commands {CMD} to the memory controller 110 to achieve seamless processing, wherein the dynamic configuration optimization performed by the memory controller 110 based on the dynamically optimized access control scheme enables the host device 50 and the memory controller 110 to evenly share the workload, rather than making the host device 50 bear most of the time consumption.

Some implementation details regarding the method can be further illustrated as follows. For example, the at least one predetermined rule may include:
(1) a first predetermined rule: when the queue depth QD falls in the first predetermined range, the memory controller 110 may enable the interrupt coalescing, and more particularly, may dynamically adjust one or more aggregation parameters among the multiple aggregation parameters (e.g., the aggregation threshold THR and the aggregation time TIME), in order to accelerate completion of the host side access control regarding the set of commands {CMD} and optimize timings of the multiple MSIs {INT} with respect to the multiple sets of commands {{CMD}, . . . {CMD}}; and
(2) a second predetermined rule: when the queue depth QD does not fall in the first predetermined range, the memory controller 110 may disable (or avoid enabling) the interrupt coalescing, and more particularly, may set (or retain) TIME=0;
wherein the first predetermined rule and the second predetermined rule may be referred to as a predetermined enabling rule and a predetermined disabling rule, respectively, but the present invention is not limited thereto. A first predetermined condition adopted by the first predetermined rule (e.g., the queue depth QD falls in the first predetermined range) and a second predetermined condition adopted by the second predetermined rule (e.g., the queue depth QD does not fall in the first predetermined range) may vary. For example:
(1) the first predetermined condition may include a condition that the queue depth QD falls in the first predetermined range, and may further include another condition that a data length L_{DATA} of the I/P commands {CMD} from the host device 50 (e.g., the read commands {CMD_{READ}} and/or the write commands {CMD_{WRITE}}) falls in a second predetermined range; and
(2) the second predetermined condition may include a condition that at least one of a condition that the queue depth QD does not fall in the first predetermined range and another condition that the data length L_{DATA} of the I/P commands {CMD} from the host device 50 does not fall in the second predetermined range is true;
wherein the second predetermined range may represent a predetermined interval of the data length L_{DATA} (e.g., an interval [4, 128] in units of KB) that can be regarded as an interval of a medium and low data length, but the present invention is not limited thereto. For example, the predetermined interval of the data length L_{DATA} may vary.

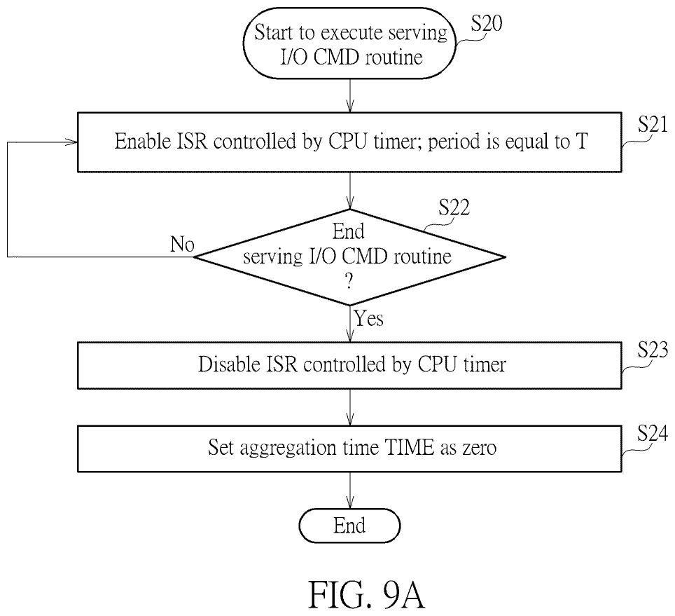

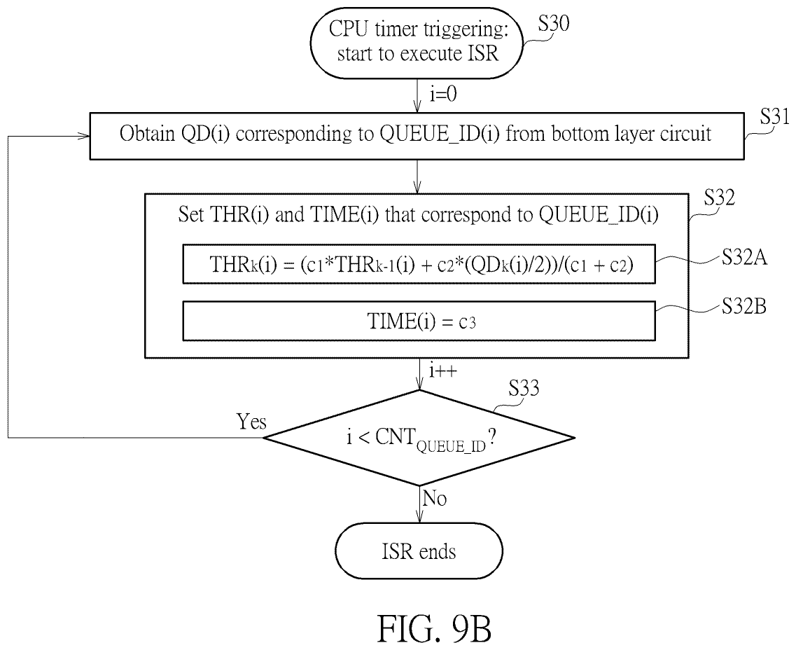

FIG. 9A is a diagram illustrating a work flow of a serving I/O command (CMD) routine involved in the method according to an embodiment of the present invention. FIG. 9B is a diagram illustrating a work flow of the ISR involved in the serving I/O CMD routine shown in FIG. 9A, wherein the work flow shown in FIG. 9B may correspond to the k^{th} processing, and more particularly, may be arranged to control the memory controller 110 to perform the k^{th} processing, without setting the circuit architecture shown in FIG. 2A in the memory controller 110, but the present invention is not limited thereto. In addition, the memory controller 110 may execute the work flows shown in FIG. 9A and FIG. 9B by the microprocessor 112 running a program code (e.g., an in-system program (ISP) code) to perform related operations of the method.

As shown in FIG. 9A, in Step S20, the memory controller 110 may start to execute the serving I/O CMD routine.

In Step S21, the memory controller 110 may enable the ISR controlled by the CPU timer, and may control the CPU timer for triggering a period of the ISR to be equal to a predetermined period T.

In Step S22, the memory controller 110 may determine whether to end the serving I/O CMD routine. If Yes, Step S23 is entered; if No, Step S21 is entered to keep enabling the ISR controlled by the CPU timer, for continuing to trigger the ISR per predetermined period T.

In Step S23, the memory controller 110 may disable the ISR controlled by the CPU timer.

In Step S24, the memory controller 110 may set the aggregation time TIME as zero.

As shown in FIG. 9B, in Step S30, the memory controller 110 may start to execute the ISR by triggering of the CPU timer. Since the CPU timer triggers the execution of the ISR per predetermined period T, a period of the execution of the ISR is equal to the predetermined period T.

In Step S31, the memory controller 110 may obtain the queue depth QD(i) corresponding to the queue ID QUEUE_ID(i) from the bottom layer circuit 118B. For example, the number of queue IDs {QUEUE_ID(i)} may be equal to a queue ID count CNT_{QUEUE_ID}, and the memory controller 110 may execute a loop including Steps S31, S32, and S33 CNT_{QUEUE_ID} times to obtain the queue depths {QD(i)} that respectively correspond to the queue IDs {QUEUE_ID(i)}.

In Step S32, the memory controller 110 may set the aggregation threshold THR(i) and the aggregation time TIME(i) that correspond to the queue ID QUEUE_ID(i). For example, Step S32 may include multiple sub-steps (e.g., Steps S32A and S32B).

In Step S32A, according to a queue depth QDₖ(i) of the k^{th} processing (e.g., the queue depth QD(i) obtained in Step S31) and an aggregation threshold THRₖ₋₁(i) of the (k−1)^{th} processing (e.g., after the CPU timer was triggered last time to execute the ISR, during the execution of the work flow shown in FIG. 9B, the aggregation threshold THR(i) obtained in Step S32 when the memory controller 110 executes the loop including Steps S31, S32 and S33 for the i^{th} time), the memory controller 110 may set an aggregation threshold THRₖ(i) of the k^{th} processing as follows:

THRₖ(i)=((c₁*THRₖ₋₁(i)+c₂*(QDₖ(i)/2))/(c₁+c₂));

wherein under control of the microprocessor 112, the memory controller 110 may respectively load the set of predetermined values (1/(c₁+c₂)), c₁, c₂, and c₃ from the predetermined region within the NV memory 120 (e.g., the system region) into the RAM 116 in advance, for performing calculation of the aggregation threshold THRₖ(i), but the present invention is not limited thereto. For example, the set of predetermined values (1/(c₁+c₂)), c₁, c₂, and c₃ may also be stored in any type of memory.

In Step S32B, the memory controller 110 may set the aggregation time TIME(i) according to the predetermined value c₃, and more particularly, may set TIME(i)=c₃.

In Step S33, the memory controller 110 may determine whether the index I is less than the queue ID count CNT_{QUEUE_ID}. If Yes, Step S31 is entered to execute the loop including Steps S31, S32, and S33 for the next time; if No, work flow of the ISR regarding the k^{th} processing ends (labeled as “ISR ends” in FIG. 9B for brevity).

For better comprehension, the method may be illustrated with the working flow shown in FIG. 9A and FIG. 9B, but the present invention is not limited thereto. According to some embodiments, one or more steps may be added, deleted, or changed in the working flow shown in FIG. 9A and FIG. 9B.

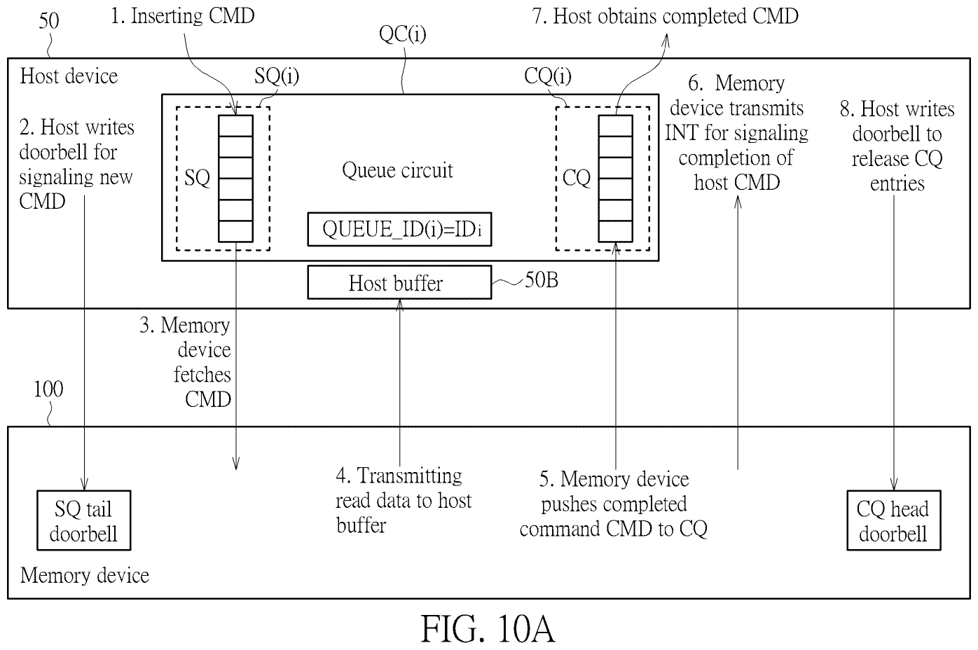

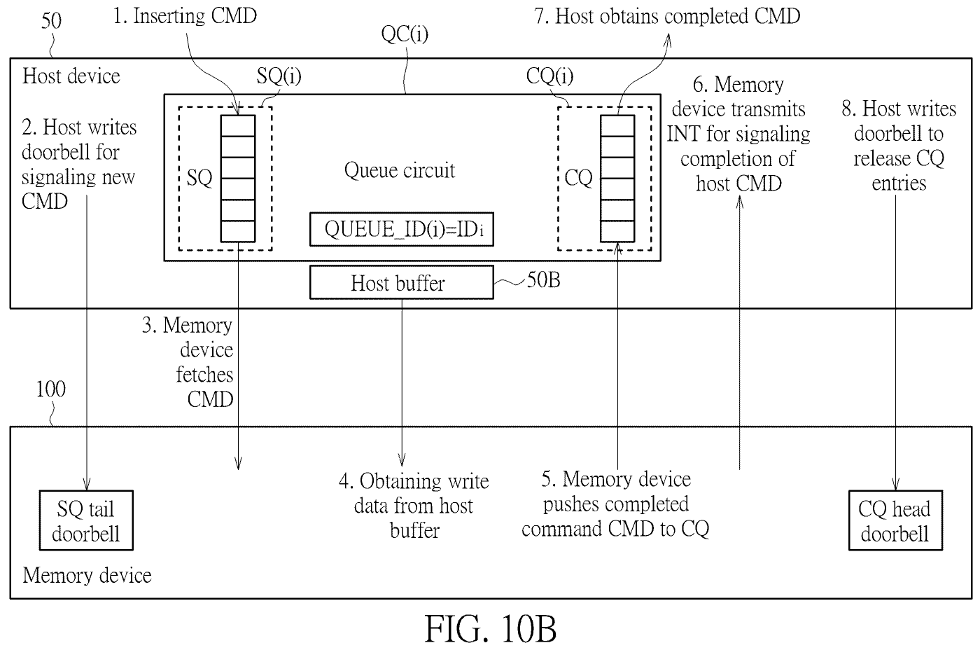

FIG. 10A is a diagram illustrating an example of access control involved in the method. FIG. 10B is a diagram illustrating another example of access control involved in the method, wherein the access control may include host side access control and device side access control regarding at least one CMD (e.g., the set of commands {CMD} among the multiple sets of commands {{CMD}, . . . , {CMD}}). The host device 50 may control (e.g., identify and/or access) the multiple queue circuits {QC(i)} according to the queue IDs {QUEUE_ID(i)}, and process any command CMD among the at least one command CMD by the queue circuit QC(i) corresponding to the queue ID QUEUE_ID(i) among the multiple queue circuits {QC(i)}. For example, the queue ID QUEUE_ID(i) may be equal to a predetermined value IDᵢ, and the queue circuit QC(i) may include a submission queue (SQ) SQ(i) and a completion queue (CQ) CQ(i) that correspond to the queue ID QUEUE_ID(i) (e.g., QUEUE_ID(i)=IDᵢ), but the present invention is not limited thereto.

As shown in FIG. 10A, when the command CMD represents a read command CMD_{READ}, operations associated with the read command CMD_{READ} may include:
(1) the host device 50 may insert the command CMD (e.g., the read command CMD_{READ}) into the SQ SQ(i) (labeled as “Inserting CMD” for brevity);
(2) the host device 50 may write a first doorbell (e.g., an SQ tail doorbell) in the memory device 100, for indicating a new command (e.g., the command CMD) by signaling (labeled as “Host writes doorbell for signaling new CMD” for brevity);
(3) the memory device 100 may fetch the command CMD (e.g., the read command CMD_{READ}) from the SQ SQ(i) (labeled as “Memory device fetches CMD” for brevity);
(4) the memory device 100 may transmit read data (e.g., data read from the NV memory 120) to a host buffer 50B within the host device 50 (labeled as “Transmitting read data to host buffer” for brevity);
(5) the memory device 100 may push a completed command CMD (or completion information thereof) to the CQ CQ(i);
(6) the memory device 100 may transmit an interrupt INT (e.g., an MSI MSI-X_INT) for indicating completion of the command CMD from the host device 50 by signaling (labeled as “Memory device transmits INT for signaling completion of host CMD” for brevity);
(7) the host device 50 may obtain the completion information of the command CMD from the CQ CQ(i) (labeled as “Host obtains completed CMD” for brevity); and
(8) the host device 50 may write a second doorbell (e.g., a CQ head doorbell) in the memory device 100 for releasing completed CQ entries (labeled as “Host writes doorbell to release CQ entries” for brevity);
wherein in the above-mentioned operations, the operations performed by the host device 50 and the operations performed by the memory device 100 may belong to the host side access control and the device side access control regarding the at least one command CMD, respectively, but the present invention is not limited thereto.

As shown in FIG. 10B, when the command CMD represents a write command CMD_{WRITE}, operations associated with the write command CMD_{WRITE} may include:
(1) the host device 50 may insert the command CMD (e.g., the write command CMD_{WRITE}) into the SQ SQ(i) (labeled as “Inserting CMD” for brevity);
(2) the host device 50 may write the first doorbell (e.g., the SQ tail doorbell) in the memory device 100, for indicating a new command (e.g., the command CMD) by signaling (labeled as “Host writes doorbell for signaling new CMD” for brevity);
(3) the memory device 100 may fetch the command CMD (e.g., the write command CMD_{WRITE}) from the SQ SQ(i) (labeled as “Memory device fetches CMD” for brevity);
(4) the memory device 100 may obtain write data (e.g., data to be written into the NV memory 120) from the host buffer 50B within the host device 50 (labeled as “Obtaining write data from host buffer” for brevity);
(5) the memory device 100 may push a completed command CMD (or completion information thereof) to the CQ CQ(i);
(6) the memory device 100 may transmit an interrupt INT (e.g., an MSI MSI-X_INT) for indicating completion of the command CMD from the host device 50 by signaling (labeled as “Memory device transmits INT for signaling completion of host CMD” for brevity);
(7) the host device 50 may obtain the completion information of the command CMD from the Co CQ(i) (labeled as “Host obtains completed CMD” for brevity); and
(8) the host device 50 may write the second doorbell (e.g., the CQ head doorbell) in the memory device 100 for releasing completed CQ entries (labeled as “Host writes doorbell to release CQ entries” for brevity);
wherein in the above-mentioned operations, the operations performed by the host device 50 and the operations performed by the memory device 100 may belong to the host side access control and the device side access control regarding the at least one command CMD, respectively, but the present invention is not limited thereto.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing access control of a memory device with aid of interrupt management, the method being applicable to a memory controller of the memory device, the memory device comprising the memory controller and a non-volatile (NV) memory, the NV memory comprising at least one NV memory element, the at least one NV memory element comprising a plurality of blocks, the method comprising:
utilizing the memory controller to receive a set of commands from a host device through a transmission interface circuit within the memory controller, wherein a command count of the set of commands is greater than one, and any command among the set of commands indicates a request for accessing the memory device; and
in response to the set of commands, utilizing the memory controller to perform a set of accessing operations upon the NV memory for the host device, and return a single message-signaled interrupt (MSI) corresponding to the set of commands to the host device by the transmission interface circuit, for notifying the host device of completion of device side access control of the memory device regarding the set of commands, to allow the host device to complete host side access control of the host device regarding the set of commands, wherein the set of accessing operations comprises a corresponding accessing operation performed by the memory controller in response to the command among the set of commands.

2. The method of claim 1, wherein the single MSI is implemented by one of a non-extended MSI and an extended MSI (MSI-X).

3. The method of claim 1, wherein the set of commands represents a first set of commands among multiple sets of commands, and the multiple sets of commands comprise the first set of commands and a second set of commands; the set of accessing operations represents a first set of accessing operations among multiple sets of accessing operations, and the multiple sets of accessing operations comprise the first set of accessing operations and a second set of accessing operations; the single MSI represents a first MSI corresponding to the first set of commands among multiple MSIs, and the multiple MSIs comprise the first MSI and a second MSI; and the method further comprises:
utilizing the memory controller to receive the second set of commands from the host device through the transmission interface circuit within the memory controller, wherein a command count of the second set of commands is greater than one, and any command among the second set of commands indicates a request for accessing the memory device; and
in response to the second set of commands, utilizing the memory controller to perform the second set of accessing operations upon the NV memory for the host device, and return the second MSI corresponding to the second set of commands to the host device by the transmission interface circuit, for notifying the host device of completion of device side access control of the memory device regarding the second set of commands, to allow the host device to complete host side access control of the host device regarding the second set of commands, wherein the second set of accessing operations comprises a corresponding accessing operation performed by the memory controller in response to the command among the second set of commands.

4. The method of claim 1, wherein the set of commands comprises a combination or one of a read command and a write command.

5. The method of claim 1, wherein:
in response to the command among the set of commands being a read command, the memory controller is arranged to read stored data from the NV memory as read data, for transmitting to the host device; and
in response to the command among the set of commands being a write command, the memory controller is arranged to write data from the host device into the NV memory.

6. The method of claim 1, wherein the device side access control regarding the set of commands comprises:
accessing a host buffer within the host device; and
pushing at least one completed command to at least one completion queue (CQ) within the host device.

7. The method of claim 6, wherein:
in response to the command among the set of commands being a read command, accessing the host buffer within the host device comprises transmitting read data to the host buffer, wherein the read data is read from the NV memory; and
in response to the command among the set of commands being a write command, accessing the host buffer within the host device comprises obtaining write data from the host buffer, for being written into the NV memory.

8. The method of claim 1, wherein the host side access control regarding the set of commands comprises:
obtaining completion information of at least one command from at least one completion queue (CQ) within the memory device; and
writing at least one CQ head doorbell within the memory device, to release at least one CQ entry in the at least one CQ.

9. The method of claim 8, wherein the host side access control regarding the set of commands further comprises:
before the device side access control regarding the set of commands is performed by the memory device, inserting at least one host command into at least one submission queue (SQ) as at least one new command; and
writing at least one SQ tail doorbell within the memory device, for indicating the at least one new command by signaling.

10. The method of claim 1, wherein the memory controller is arranged to dynamically adjust at least one configuration of at least one component within the memory controller, to minimize a total time of the host side access control of the host device regarding the set of commands.

11. The method of claim 10, wherein the at least one component comprises the transmission interface circuit, and the at least one configuration comprises a set of configurations of a bottom layer circuit within the transmission interface circuit.

12. The method of claim 11, wherein the set of configurations of the bottom layer circuit represents configurations determined by multiple parameters of the bottom layer circuit.

13. The method of claim 1, wherein the memory controller is arranged to dynamically adjust at least one parameter of the transmission interface circuit, for accelerating completion of the host side access control regarding the set of commands.

14. The method of claim 13, wherein the memory controller is arranged to dynamically adjust the at least one parameter to perform access control in response to a latest state of an electronic device, for accelerating the completion of the host side access control regarding the set of commands.

15. The method of claim 13, wherein the at least one parameter comprises multiple parameters of a bottom layer circuit within the transmission interface circuit; and the memory controller is arranged to dynamically adjust the multiple parameters of the bottom layer circuit by at least one upper layer circuit within the memory controller, for accelerating the completion of the host side access control regarding the set of commands.

16. The method of claim 13, wherein the at least one parameter comprises multiple aggregation parameters; and the memory controller is arranged to dynamically adjust the multiple aggregation parameters according to at least one predetermined rule, for accelerating the completion of the host side access control regarding the set of commands.

17. The method of claim 13, wherein the at least one parameter comprises multiple aggregation parameters; the set of commands represents a first set of commands among multiple sets of commands, the set of accessing operations represents a first set of accessing operations among multiple sets of accessing operations, and the single MSI represents a first MSI corresponding to the first set of commands among multiple MSIs; and the memory controller is arranged to dynamically adjust the multiple aggregation parameters, to optimize timings of the multiple MSIs with respect to the multiple sets of commands.

18. A memory controller of a memory device, the memory device comprising the memory controller and a non-volatile (NV) memory, the NV memory comprising at least one NV memory element, the at least one NV memory element comprising a plurality of blocks, the memory controller comprising:
a processing circuit, arranged to control the memory controller according to a plurality of host commands from a host device, to allow the host device to access the NV memory through the memory controller, wherein the processing circuit is arranged to perform access control of the memory device with aid of interrupt management; and
a transmission control circuit, arranged to perform communications with the host device;
wherein:
the memory controller receives a set of commands from the host device through the transmission interface circuit within the memory controller, wherein a command count of the set of commands is greater than one, and any command among the set of commands indicates a request for accessing the memory device; and
in response to the set of commands, the memory controller performs a set of accessing operations upon the NV memory for the host device, and returns a single message-signaled interrupt (MSI) corresponding to the set of commands to the host device by the transmission interface circuit, for notifying the host device of completion of device side access control of the memory device regarding the set of commands, to allow the host device to complete host side access control of the host device regarding the set of commands, wherein the set of accessing operations comprises a corresponding accessing operation performed by the memory controller in response to the command among the set of commands.

19. The memory device comprising the memory controller of claim 18, wherein the memory device comprises:
the NV memory, arranged to store information; and
the memory controller, coupled to the NV memory, and arranged to control operations of the memory device.

20. An electronic device comprising the memory device of claim 19, and further comprising:
the host device, coupled to the memory device, wherein the host device comprises:
at least one processor, arranged to control operations of the host device; and
a power supply circuit, coupled to the at least one processor, and arranged to provide power to the at least one processor and the memory device;
wherein the memory device provides the host device with storage space.
